(19) United States
(12) Patent Application Publication
(10) Pub. No.: US 2016/0196074 A1
(43) Pub. Date: Jul. 7, 2016

(54) DATA ARRANGEMENT APPARATUS, STORAGE MEDIUM, AND DATA ARRANGEMENT METHOD

(71) Applicant: FUJITSU LIMITED, Kawasaki-shi (JP)

(72) Inventors: Hidekazu TAKAHASHI, Kawasaki (JP); Miho Murata, Kawasaki (JP)

(73) Assignee: FUJITSU LIMITED, Kawasaki-shi (JP)

(21) Appl. No.: 14/977,925

(22) Filed: Dec. 22, 2015

(30) Foreign Application Priority Data
Jan. 6, 2015 (JP) 2015-001068

(51) Int. Cl. G06F 3/06; G06F 12/08

(52) U.S. Cl. CPC G06F 3/0613; G06F 12/0866; G06F 3/0685; G06F 3/0665; G06F 2212/224

(57) ABSTRACT

A data arrangement apparatus includes a processor executing a process including: selecting one or more data segments from a first storage device according to a free capacity of the first storage device that stores a plurality of data segments, each of the plurality of data segments being a data group grouped according to data relevance between data included in the data group; calculating an evaluation value based on the data relevance between the data included in the selected data segments; and determining arrangement positions of the selected data segments in storage areas of a second storage device based on the evaluation value and readout performance information of a plurality of storage areas in the second storage device in which readout performance differs by the plurality of storage areas.

### CROSS-REFERENCE TO RELATED APPLICATIONS

This application is based upon and claims the benefit of priority of the prior Japanese Patent Application No. 2015-001068, filed on Jan. 6, 2015, the entire contents of which are incorporated herein by reference.

### FIELD

The embodiments discussed herein are related to an arrangement technique of data.

### BACKGROUND

In a storage device, a throughput in an irregular access to data having a small size is low, and cost for random access is high as compared to cost for sequential access. As a technique for improving this throughput, a cache technique is used.

The cache technique is a technique in which, when a control device in which a processing speed is fast reads out data faster from a low-speed storage device, processing time is shortened using a memory. When the control device reads out data from the low-speed storage device, the read-out data is held temporarily in the memory, and thereby, from the next time, the data can be read out from the memory faster than a hard disk in reading and writing.

About the above-described cache technique, for example, a least frequently used (LFU) algorithm and a least recently used (LRU) algorithm are used. Alternatively, as one of the cache techniques, a data relocation (technique is used in which, based on an access history, data having relevance is collected into the same data segment and is written back to a disk (e.g., Patent Literature 1).

Patent Literature 1: International Publication Pamphlet No. WO 2013/114538

### Patent Literature 2: Japanese National Publication of International Patent Application No. 2005-502121

### Patent Literature 3: Japanese Laid-open Patent Publication No. 11-85411

### Patent Literature 4: Japanese Laid-open Patent Publication No. 2011-175334

### SUMMARY

A non-transitory computer-readable recording medium has stored therein a data arrangement program that causes a computer to execute a process including: selecting one or more data segments from a first storage device according to a free capacity of the first storage device that stores a plurality of data segments, each of the plurality of data segments being a data group grouped according to data relevance between data included in the data group; calculating an evaluation value based on the data relevance between the data included in the selected data segments; and determining arrangement positions of the selected data segments in storage areas of a second storage device based on the evaluation value and readout performance information of a plurality of storage areas in the second storage device in which readout performance differs by the plurality of storage areas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a data arrangement apparatus of the present embodiment.

FIG. 2 is an example of an information processing system of the present embodiment.

FIG. 3 illustrates a record and a data segment of the present embodiment.

FIG. 4 is an example of a server of the present embodiment.

FIG. 5 is an example of a record-data segment correspondence table of the present embodiment.

FIG. 6 is an example of a relevance storage table of the present embodiment.

FIG. 7 is an example of a data segment management table of the present embodiment.

FIG. 8 is an example of an empty area management table of the present embodiment.

FIG. 9 is an example of a disk performance storage table of the present embodiment.

FIG. 10 illustrates accumulation of relevance information of the present embodiment.

FIGS. 11A-11E are an update example of the relevance storage table corresponding to FIG. 10.

FIG. 12 is an example of a flowchart illustrating a flow of the entire update processing of the data segment management table performed according to a request arrival of the present embodiment.

FIGS. 13A-13E illustrate analysis processing (S4) according to a relevance analysis unit.

FIG. 14 is a write-back flowchart of the data segment to a disk of the present embodiment.

FIG. 15 is a detailed flowchart of a process (S1) up to a point at which the record specified by a request of the present embodiment is read out from a memory or a disk and is transmitted to a request source.

FIG. 16 illustrates an arrangement of the data segment and a reading unit of the data segment according to reading efficiency of the present embodiment.

### DESCRIPTION OF EMBODIMENTS

In data segments generated by an data relocation technique, some data segments in which data having a strong relevance is aggregated and the other data segments in which data having a not-so-strong relevance is aggregated are present. In data in which reading efficiency is high, the data segment in which the data having a strong relevance is aggregated includes both types of related data. Therefore, when both types of data are readout to a cache, it is easy for a cache hit ratio to become high (namely, the reading efficiency is high). On the other hand, the data segment in which the data having a not-so-strong relevance is aggregated includes either both types of data having no relation to each other or both types of data that are related but not strongly related to each other. Therefore, even if both types of data are readout to the cache, it is difficult for the cache hit rate to become high (namely, the reading efficiency is low).

The “reading efficiency is high” or “reading efficiency is low” characteristics in the above-described data segments change according to a change in a pattern of data access or an importance level of individual data.

However, when a size, an access frequency, and characteristics of data (data segments in the case of the data relocation technique) or characteristics of disks are not considered and the data are written back, the data segments in which the reading efficiency is different are mixed and written back. As a result, when the data are then collectively read out from the disks, useless data also are read out.

Further, in sequential read performance of the disk, the outer peripheral side of the disk has a shorter read time of the data than the inner peripheral side thereof, namely, the outer peripheral side has a higher sequential read performance than the inner peripheral side. Thus, in the sequential read performance of the disk, for example, a performance difference of 1.5 to 2 times at a maximum is present based on a physical position (the inner peripheral side or the outer peripheral side of the disk) of the data. Accordingly, when the data having a large size is readout from the disk, the read time is largely different based on the physical position of the data.

However, the collective readout of the data has a larger read cost than the readout of a single piece of data. Therefore, when the data segment in which the reading efficiency is low is recorded on the inner peripheral side, the read cost at the time of collectively reading out data becomes large as compared to a case in which the data is recorded on the outer peripheral side.

In the present embodiment, as one aspect, a technique is provided of improving the reading efficiency of the data from a storage device in which the readout performance differs according to positions of memory areas.

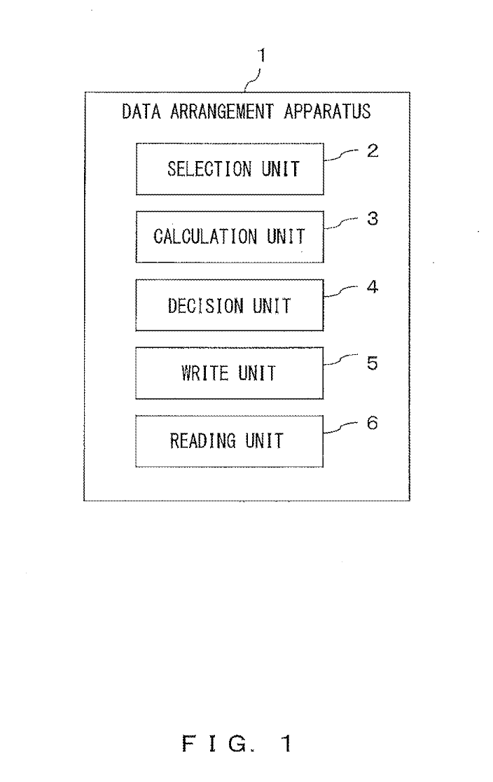

FIG. 1 is an example of a data arrangement apparatus of the present embodiment. The data arrangement apparatus 1 includes a selection unit 2, a calculation unit 3, and a determining unit 4. As an example of the data arrangement apparatus 1, a server 11 is included.

The selection unit 2 selects one or more data segments from a first storage device according to a free capacity of the first storage device that stores a plurality of data segments. Each of the plurality of data segments is a data group grouped according to data relevance between data included in the data group. As an example of the selection unit 2, a control device 21 serving as a write-back execution unit 26 is included. As an example of the first storage device, a memory 31 is included.

The calculation unit 3 calculates an evaluation value based on the data relevance between the data included in the selected data segments. As an example of the calculation unit 3, the control device 21 serving as a characteristic extraction unit 27 is included. As an example of a second storage device, a disk 41 is included.

The determining unit 4 determines arrangement positions of the selected data segments in storage areas of a second storage device based on the evaluation value and readout performance information of a plurality of storage areas in the second storage device in which readout performance differs by the plurality of storage areas. As an example of the determining unit 4, the control device 21 serving as a recording place determining unit 29 is included. As an example of the information about the readout performance according to the position of the storage area, a disk performance storage table 37 is included.

In the above-described configuration, the readout efficiency of the data from the memory device in which the readout performance differs according to the position of the memory area can be improved.

The calculation unit 3 calculates the evaluation value to be higher as the data relevance between the data included in the data segments becomes stronger. Based on the evaluation value and the readout performance information, the determining unit 4 determines that the arrangement positions becomes higher in the readout performance as the evaluation value of the data segments becomes higher.

In the above-described configuration, the data segment including the data group that is easy to access is arranged in a position in which the readout performance is high, thereby suppressing an increase in the read cost.

The data arrangement apparatus 1 further includes a write unit 5. Based on the determined arrangement positions, the write unit 5 writes the selected data segments in the storage areas. As an example of the write unit 5, the control device 21 serving as the write-back execution unit 26 is included.

In the above-described configuration, the data segment in which the readout efficiency is more efficient is arranged in a position in which the readout performance is high, thereby suppressing an increase in the read cost.

The data arrangement apparatus 1 further includes the reading unit 6. According to the arrangement positions of the data segments including data specified by a read request, the reading unit 6 changes the number of data segments to be read out from the storage areas. And The reading unit 6 reads out the data segments arranged continuously in the storage areas from the arrangement positions by the number of the data segments. As an example of the reading unit 6, the control device 21 serving as an input-output management unit 22 is included.

In the above-described configuration, the higher the readout efficiency of a data segment, the higher its position in the readout performance, and therefore more data segments are collectively read out. On the other hand, the lower the readout efficiency of a data segment, the lower its position in the readout performance. However, to that extent, fewer data segments are collectively read out, or one data segment is read out. Thereby, an increase in the read cost can be suppressed.

Further, the above-described data relevance is data relevance between the data generated from an access history of the data. As a result, according to the content or nature of the data included in the data segment formed based on the access history of the data, an arrangement in the disk can be determined and an increase in the read cost can be suppressed.

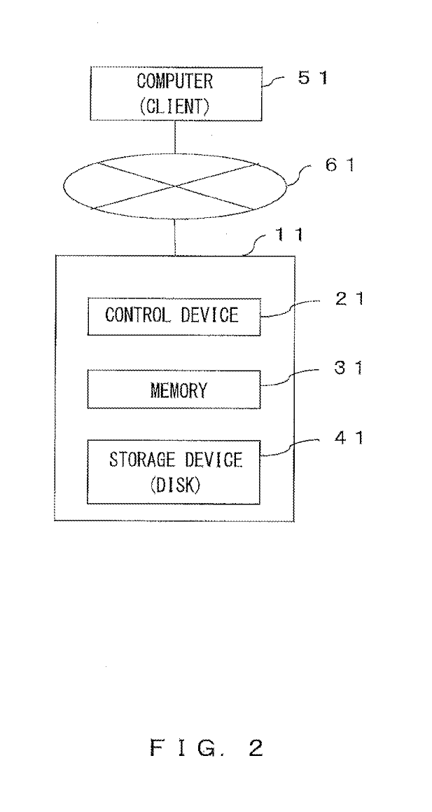

FIG. 2 is an example of an information processing system of the present embodiment. In the information processing system, the server device (hereinafter, referred to as a “server”) 11 is connected to a client 51, which is an example of an information processing device, via a communication network (hereinafter, referred to simply as a “network”) 61. The client 51 performs an access request (hereinafter, referred to as a “request”) to the server 11 such as reading or writing of the data. In the present embodiment, data specified by one request is referred to as a “record”.

The server 11 includes the control device 21, the memory device (hereinafter, referred to as a “memory”) 31, and a storage device (disk) 41. The control device 21 is a processor such as a central processing unit (CPU).

The storage device 41 may be a disk device such as a hard disk drive (HDD). Hereinafter, the storage device 41 is referred to as the disk 41.

The memory 31 is a memory device accessible at a higher speed than the disk 41. The memory 31 may be, for example, a RAM (Random Access Memory), a flash memory, and the like.

In addition to the above-described configuration, the server 11 has a ROM that stores a BIOS (Basic Input/Output System), a program memory, and the like. A program that is executed by the control device 21 may be obtained via the network 61, or may be obtained by mounting on the server 11 a computer-readable portable storage medium such as a portable memory and a CD-ROM. The program that is executed by the control device 21 also includes a program in which processing described in the present embodiment is performed.

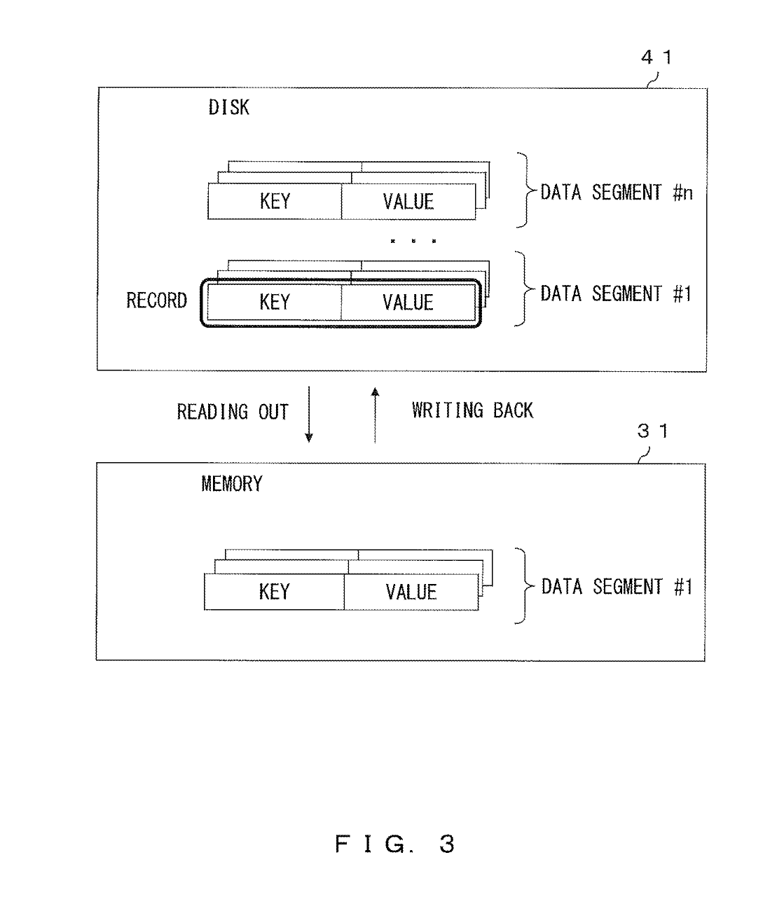

In the present embodiment, when data in the memory 31 is written back to the disk 41, the control device 21 also considers characteristics that are due to content of the records or characteristics of record processes and determines a recording place in the disk 41. The characteristics due to content of the records are characteristics of the importance level of the records, the number of times access, etc. Further, the characteristics due to the content of the record processes are characteristics using the access history based on a rule of thumb that related records are accessed and processed at the same time. The characteristics due to the content of the records or the content of the record processes exert an influence on the readout efficiency of a reading unit (data segment). Details of the data segment will be described in FIG. 3. The recording place in the disk is divided into a plurality of areas in which the sequential read performance differs significantly. The control device 21 may specify any area and writes one or more data segments in the specified area according to the reading efficiency.

When the data segments are written back to the disk 41, the control device 21 collectively writes back a plurality of data segments. The control device 21 calculates a priority of each of the plurality of data segments written back collectively and allocates the data segments to the area having a higher performance in the order of the data segment having higher priority

The control device 21 extracts data characteristics (an index indicating an aptitude) whenever the data process (new preparation, reference, update (rearrangement using the data relocation technique etc.), and the like) is generated and stores characteristic information thereof in each piece of data.

When the plurality of data segments are written back to the disk, the control device 21 calculates the priority of each data segment based on the characteristic information stored at the time of the data process.

FIG. 3 illustrates the records and the data segments of the present embodiment. In the present embodiment, for convenience of description, the data specified by a request is represented as the record. The record includes a “key” and a “value”. The “key” is information for uniquely discriminating the record (value). The “value” is content (value) of the record specified by the “key”.

In the disk 41, the record is stored in units of the data segment. The data segment is a set of the record in which data relevance is recognized based on the record history specified by the request, and is a minimum unit of reading and writing with respect to the disk 41. The data segment content is updated by a process of the control device 21 as described below. Here, the request includes a Read request and a Write request.

In the present embodiment, for example, a data segment size is assumed to be a fixed size. Further, when the data segment is written back from the memory to the disk, a unit (the number of the data segments) in which the data segment is collectively written is adjusted.

The record is read out from the disk 41 in units of the data segment, and is stored in the memory 31. That is, all the records included in the data segment to which the record specified by the request belongs are read out from the disk 41, and are stored in the memory 31. Further, when a capacity of the memory 31 becomes deficient, the record stored in the memory 31 is written back to the disk 41 in units of the data segment.

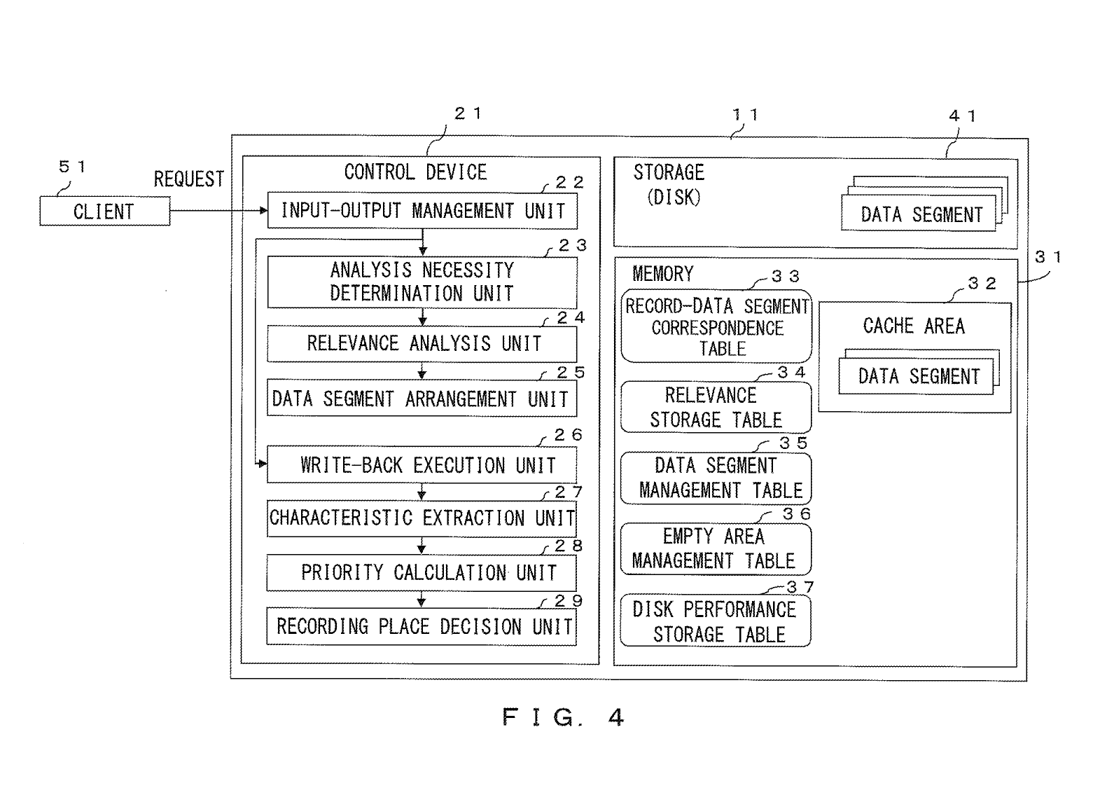

FIG. 4 is an example of the server of the present embodiment. As described above, the server 11 includes the control device 21, the memory 31, and the disk 41. The memory 31 includes an area (hereinafter, referred to as a “cache area”) in which the plurality of data segments read out from the disk 41 are cached and temporarily stored. When the capacity of the cache area 32 becomes deficient, any of the data segments may be extracted from the cache area 32 using an algorithm of an LRU algorithm, an LFU algorithm, etc. and are written back to the disk 41.

The memory 31 has a record-data segment correspondence table 33, a relevance storage table 34, a data segment management table 35, an empty area management table 36, and the disk performance storage table 37. The record-data segment correspondence table 33 stores information representing a correspondence relationship between the key for specifying the record and the data segment to which the record belongs. The relevance storage table 34 is a table for managing related information in which the records specified by the previous request are sequentially related in each record specified by the request and are accumulated. The data segment management table 35 is a table for managing a physical position and characteristics (an index value) in each data segment in the disk 41. The empty area management table 36 is a table for managing empty areas in the disk 41. The disk performance storage table 37 is a table for managing a readout performance in each physical position in the disk 41.

The control device 21 executes programs according to the present embodiment, and thereby serves as the input-output management unit 22, an analysis necessity determination unit 23, a relevance analysis unit 24, a data segment arrangement unit 25, the write-back execution unit 26, the characteristic extraction unit 27, a priority calculation unit 28, and the recording place determining unit 29.

The input-output management unit 22 searches the memory 31 according to requests input from a request source such as the client 51, and if the record specified by the request is not present in the memory 31, further searches the disk 41, and transmits the record specified by the request to the request source. Not only the request is transmitted by the client 51 but also a main body of processes or the like performed in the server 11 may be an issue source of the requests. Further, when an input-output device is connected to the server 11, a user is assumed to input the request to the input-output device.

When a request is input, the input-output management unit 22 first searches the memory 31 for the record specified by the request. When the record specified by the request is present in the memory 31, the input-output management unit 22 reads out the record from the memory 31 and sends back the read-out record to the request source.

Further, when the record specified by the request is not present in the memory 31, the input-output management unit 22 searches the disk 41 for the record specified by the request. When the record specified by the request is present in the disk 41, the input-output management unit 22 reads out from the disk 41, using the record-data segment correspondence table 33, all of the records included in the data segment to which the record specified by the request belongs. Further, the input-output management unit 22 sends back the record specified by the request to the request source from among all the records included in the read-out data segment. At this time, the input-output management unit 22 stores in the memory 31 all the records included in the read-out data segment.

In the above, a case in which the input-output management unit 22 performs a process of storing all the records included in the data segment read out from the disk 41 in the memory 31 at a timing at which the request is received is described; however, it is not limited thereto. For example, the input-output management unit 22 may obtain an access frequency in a certain prescribed period and read out from the disk 41 preferentially the data segment in which the access frequency is high to store the data segment in the memory 31.

Using the relevance storage table 34, the analysis necessity determination unit 23 determines whether the data segments to which the record specified between the continuous requests belongs are the same, and thereby determines whether the relevance analysis unit 24 is caused to perform an analysis of the relevance.

According to determination results of the analysis necessity determination unit 23, the relevance analysis unit 24 analyzes from the relevance storage table 34 the data relevance between the record of the data segment to which the record specified by the current request belongs and the record of the data segment to which the record specified by the previous request belongs. Based on the analysis results, the relevance analysis unit 24 determines the data segment to which the record belongs.

According to the determination of the relevance analysis unit 24, the data segment arrangement unit 25 updates an arrangement of the data segments of the record-data segment correspondence table 33.

Based on an instruction from the input-output management unit 22, when the capacity of the cache area 32 is deficient, the write-back execution unit 26 performs the write-back processing. When the write-back processing is performed, the write-back execution unit 26 calls out the characteristic extraction unit 27, the priority calculation unit 28, and the recording place determining unit 29. After the processing of the characteristic extraction unit 27, the priority calculation unit 28, and the recording place determining unit 29, the write-back execution unit 26 writes back a write-back target data segment to an area in the disk allocated by the recording place determining unit 29 described later.

With reference to the record-data segment correspondence table 33 and the relevance storage table 34, the characteristic extraction unit 27 calculates an index value indicating a height of the reading efficiency as characteristics of the data segment, and stores the calculated index value in the data segment management table 35.

Based on the calculated index value, the priority calculation unit 28 determines a priority of a height of the reading efficiency in each data segment.

With reference to the empty area management table 36 and the disk performance storage table 37, the recording place determining unit 29 sequences an empty area in the order of disk performance according to a physical position of the disk of the empty area. The recording place determining unit 29 allocates all the data segments in which the priority is determined to empty areas in which the disk performance is higher in descending order of priority.

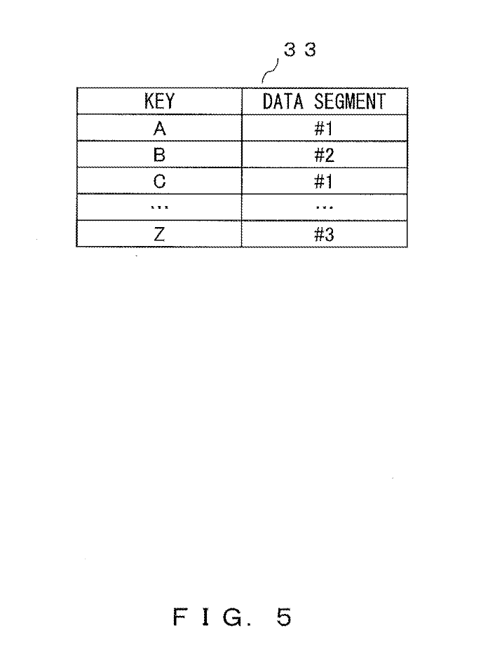

FIG. 5 is an example of the record-data segment correspondence table of the present embodiment. Keys of all the records stored in the memory 31 and the disk 41 are associated with data segment names corresponding to the keys and are stored in the record-data segment correspondence table 33.

The record-data segment correspondence table 33 includes items of the “key” and the “data segment”. The “key” is information for specifying the record, and corresponds to a record name. The data segment represents a data segment to which the record specified by the key belongs.

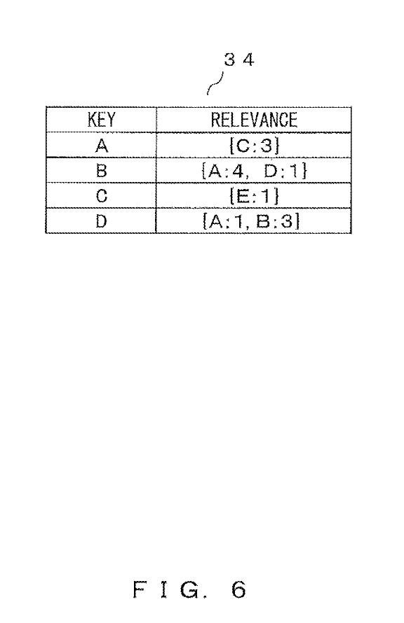

FIG. 6 is an example of the relevance storage table 34 of the present embodiment. The relevance storage table 34 is a table for records that are held in the cache area 32. The relevance storage table 34 is a table in which the records specified by the current request are associated with the records specified by the previous request.

The relevance storage table 34 includes items of the “key” and the “relevance”. The key represents information for specifying the record and corresponds to a record name.

“key” K2 of the record specified by the request before the “key” K1, indicating the record specified by the current request, and an intensity n of the relevance between K1 and K2 are sequentially accumulated and stored in the item of the “relevance”. In FIG. 6, the relevance is described as {K2:n}. The intensity n of the relevance is described as the number of times of the access×the importance level. The intensity of the relevance will be described later.

For example, the record specified by the current request is assumed to be ‘A’, the record specified by the previous request is assumed to be ‘C’, and the intensity of the relevance between the records A and C is assumed to be 3. In this case, in the relevance storage table 34, {C:3} is stored in the item “relevance” corresponding to key=A.

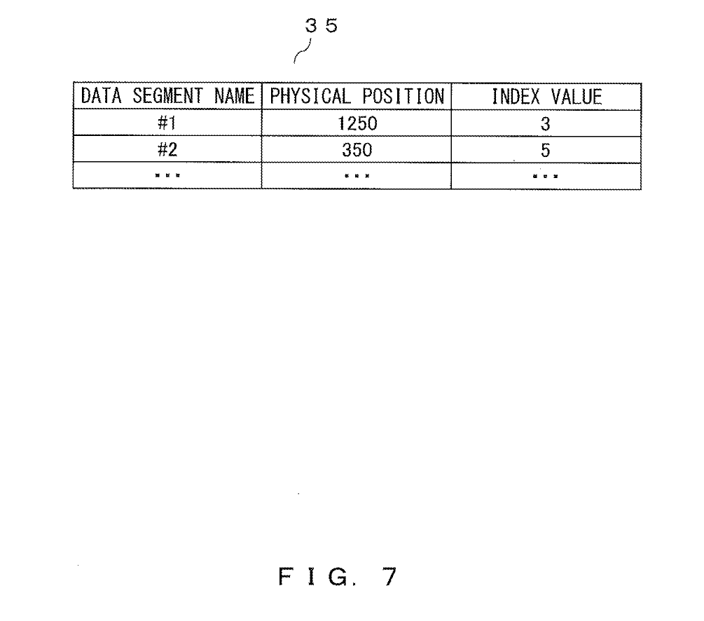

FIG. 7 is an example of the data segment management table of the present embodiment. The data segment management table 35 includes the items of the “data segment name”, the “physical position”, and the “index value”. The “data segment name” indicates information for specifying the data segment. The “physical position” indicates a physical position of the data segment in the disk 41. The “index value” is a value indicating a height of the reading efficiency of the data segment, and indicates that as the index value becomes higher, the reading efficiency becomes higher.

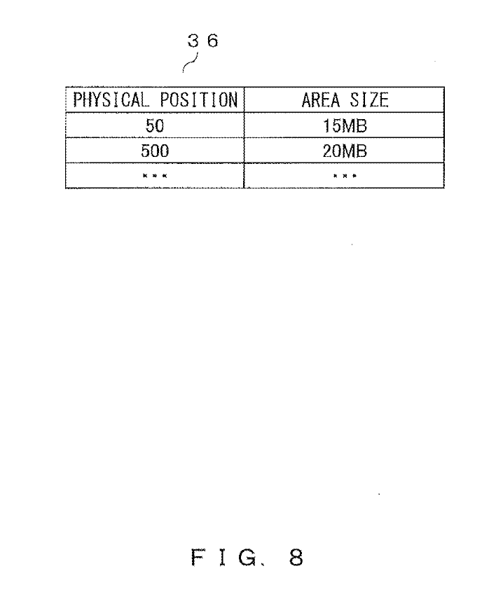

FIG. 8 is an example of the empty area management table of the present embodiment. The empty area management table 36 includes the items of the “physical position” and the “area size”. The “physical position” indicates a starting position (Logical Block Addressing (LBA)) of an area in which information is not written in the disk 41. The “area size” indicates an area size of the empty area corresponding to the physical position.

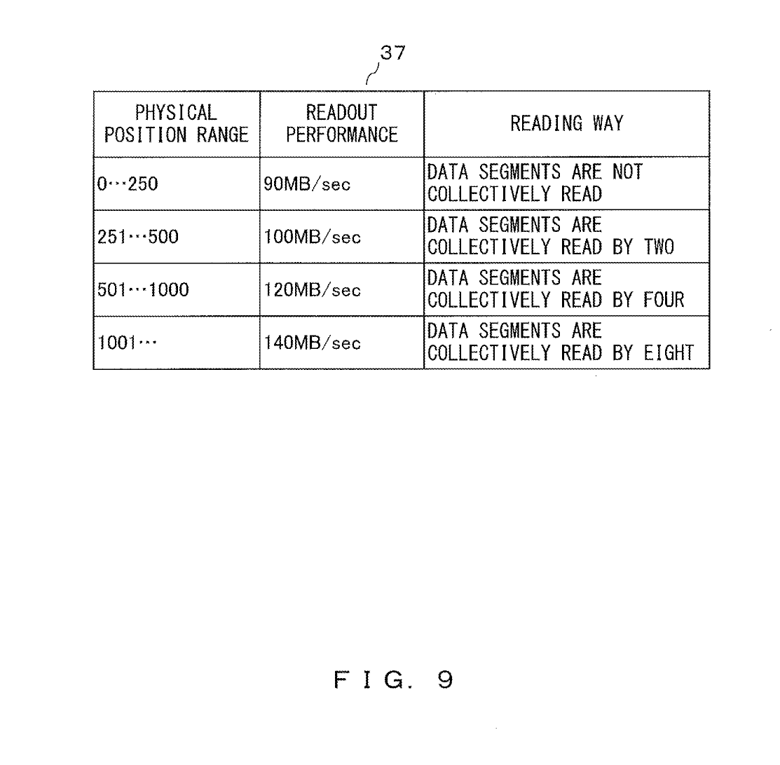

FIG. 9 is an example of the disk performance storage table of the present embodiment. The disk performance storage table 37 includes the items of the “physical position range”, the “readout performance”, and the “reading method”. The “physical position range” indicates a physical position range in the disk 41. The “readout performance” indicates a readout performance per unit time in the physical position range. The “reading method” indicates the number of the data segments in which the readout is collectively performed in the read processing of one time.

In FIG. 9, in the case of the physical position: 0 to 250, the readout performance: 90 megabyte (MB)/sec holds, and the reading method is set to “the readout is not collectively performed” (namely, the readout is performed by one data segment). In the case of the physical position: 251 to 500, the readout performance: 100 MB/sec holds, and the reading method is set to “the readout is performed by two data segments”. In the case of the physical position: 501 to 1000, the readout performance: 120 MB/sec holds, and the reading method is set to “the readout is performed by four data segments”. In the case of the physical position: 1001 or more, the readout performance: 140 MB/sec holds, and the reading method is set to “the readout is performed by eight data segments”.

Thus, in the disk performance storage table 37, entries of the “physical position range”, the “readout performance”, and the “reading method” are set so that as the readout performance in the physical position range becomes higher, the number of the data segments to be collectively read out is further increased.

Next, accumulation processing of relevance information managed by the relevance storage table 34 will be described. In the present embodiment, the relevance is present between the records continuously accessed by the same client 51, and as the number of times of continuous accesses becomes greater, the relevance is considered to become stronger.

Further, in the present embodiment, both the records are accessed continuously by the same client, or different clients. However, the above records are discriminated from the records in which an arrival order to the input-output management unit 22 is continuous by chance, and the latter case is assumed to have no relevance.

Further, in the present embodiment, even if a request is specified by the same client, the importance level may be different depending on the record. As the importance level specified by the request becomes larger, the relevance is considered to be stronger. For example, when data processing is performed in which access logs of the Web are accumulated and the Web site is followed so each user can analyze a carrier, each Web site page corresponds to the record and the importance level is high. On the other hand, advertisement data that is attached to the Web site is also included in the record, but displayed at random on the Web site (continuously accessed at random), and therefore the importance level is low.

A method for accumulating the relevance information will be described. A common session number is given to the request from the same client. Each of the requests includes a value indicating the importance level in each record. A record that is not related to other records at all is set to an importance level of zero. The importance level is specified by application programs or users that put in the request. The input-output management unit 22 checks the requests in the order of arrivals, and records the latter records continuously accessed with the common session number as the relevance information of the former records.

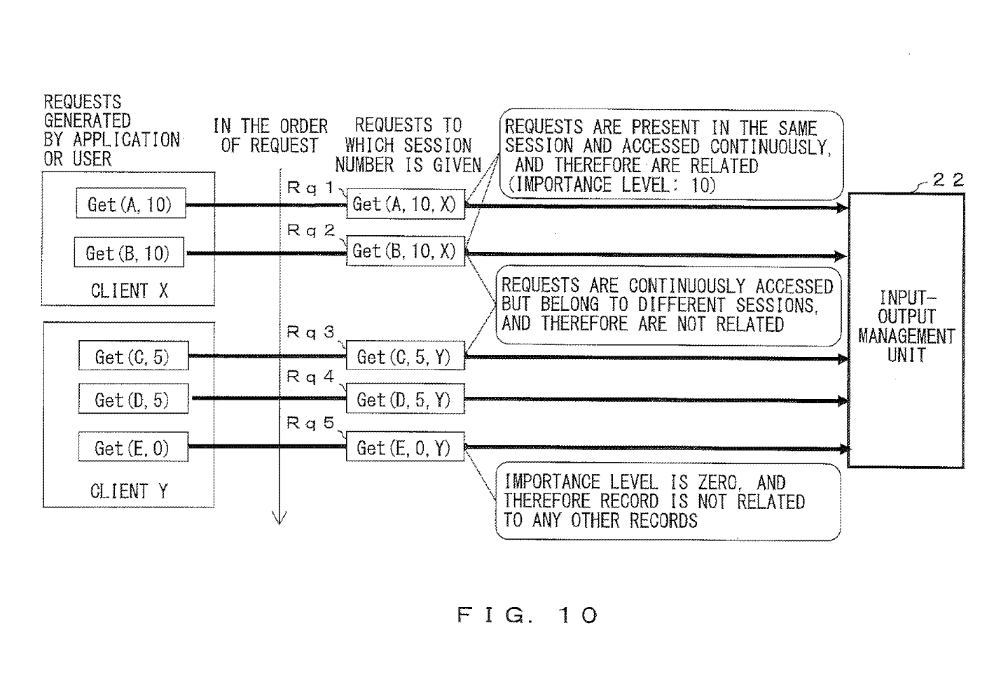

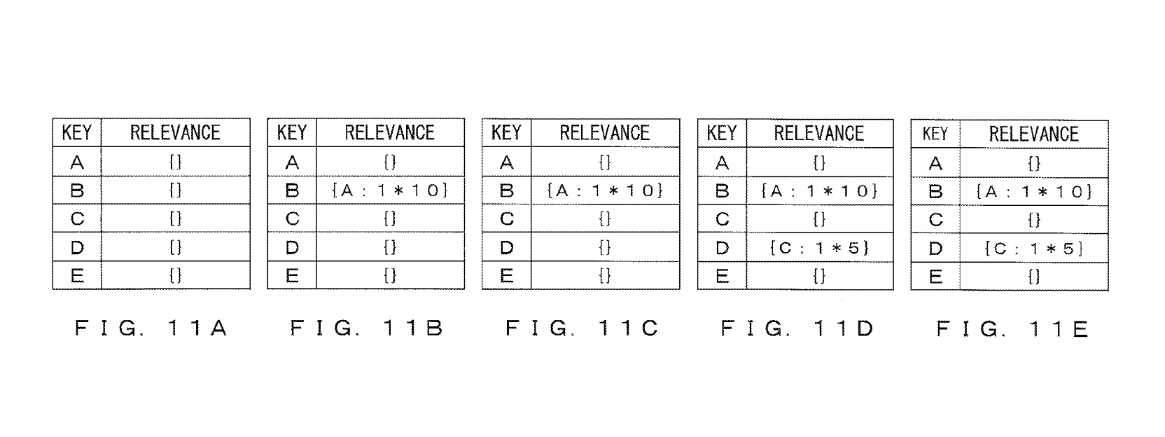

FIG. 10 illustrates the accumulation of the relevance information of the present embodiment. FIGS. 11A-11E are an update example of the relevance storage table corresponding to FIG. 10. In FIG. 10, the application programs operating in the clients X and Y or the requests generated by an instruction of the user are represented by “Get (K, N)”. Here, ‘K’ represents a key for specifying the record. ‘N’ represents a value indicating the importance level of the record.

At the time of issuance from the client, the session number is given to the generated request in each client. In FIG. 10, the request issued by the client X is represented by “Get (K, N, SeN). SeN represents the session number set in each client. In an example of FIG. 10, the session number ‘X’ is assumed to be given to the request issued by the client X. Further, the session number ‘Y’ is assumed to be given to the request issued by the client Y.

In an example of FIG. 10, the clients X and Y are assumed to issue the requests to the input-output management unit 22 in the order (order of Rq1, Rq2, Rq3, Rq4, and Rq5) indicated by arrows. In the present embodiment, not only the key of the record specified by the current request but also the key of the record specified by the previous request is assumed to be given to each request; however, it is not limited thereto. For example, the input-output management unit 22 may store histories of the requests in each request source in the memory 31, the register, etc.

First, the request Rq1: Get (A, 10, X) is issued from the client X. At this time, ‘10’ is assumed to be set to the importance level. In FIG. 10, no request is issued before the request Rq1. In this case, the input-output management unit 22 determines that the record that is related to the record ‘A’ specified by the request Rq1 is not present, and does not update the relevance storage table 34 as illustrated in FIG. 11A.

Next, the request Rq2: Get (B, 10, X) is issued by the client X. At this time, ‘10’ is assumed to be set to the importance level. A session of the request Rq2 is the same as that of the request Rq1, and the request Rq2 is continuously accessed. In this case, the input-output management unit 22 determines that the record ‘A’ specified by the request Rq1 is related to the record ‘B’ specified by the request Rq2. In this case, the input-output management unit 22 updates the relevance storage table 34 as illustrated in FIG. 11B.

Specifically, the key of the record specified by the current request Rq2 is ‘B’, and the key of the record specified by the previous request is ‘A’. Therefore, the input-output management unit 22 stores ‘A’ in the “relevance” corresponding to the key ‘B’ of the relevance storage table 34. Further, the input-output management unit 22 calculates the relevance between the record ‘B’ and ‘A’, and stores the calculated relevance in the relevance storage table 34. The relevance between the record ‘B’ and ‘A’ is calculated to be the number of times lithe importance level 10=10 in which B and A are continuously accessed (within the same session).

Next, the request Rq3: Get (C, 5, Y) is issued by the client Y. At this time, ‘5’ is assumed to be set to the importance level. The request Rq3 is accessed continuously after the request Rq2, but a session of the request Rq3 is different from that of the request Rq2. In this case, the input-output management unit 22 determines that the record ‘C’ specified by the request Rq3 is not related to the record ‘B’ specified by the request Rq2. In this case, the input-output management unit 22 does not update the relevance storage table 34 as illustrated in FIG. 11C.

Next, the request Rq4: Get (D, 5, Y) is issued by the client Y. At this time, ‘5’ is assumed to be set to the importance level. A session of the request Rq4 is the same as that of the request Rq3, and the request Rq4 is continuously accessed. In this case, the input-output management unit 22 determines that the record ‘D’ specified by the request Rq4 is related to the record ‘C’ specified by the request Rq3. In this case, the input-output management unit 22 updates the relevance storage table 34 as illustrated in FIG. 11D.

Specifically, the key of the record specified by the current request Rq4 is ‘D’, and the key of the record specified by the previous request is ‘C’. Therefore, the input-output management unit 22 stores ‘C’ in the “relevance” corresponding to the key ‘D’ of the relevance storage table 34. Further, the input-output management unit 22 calculates the relevance between the record ‘D’ and ‘C’, and stores the calculated relevance in the relevance storage table 34. The relevance between the record ‘D’ and ‘C’ is calculated to be the number of times 1×the importance level 5=5 in which D and C are continuously accessed (within the same session).

Next, the request Rq5: Get (E, 0, Y) is issued by the client Y. At this time, ‘0’ is assumed to be set to the importance level. A session of the request Rq5 is the same as that of the request Rq4, and the request Rq5 is continuously accessed. However, the importance level is 0, and therefore the input-output management unit 22 determines that the record ‘E’ specified by the request Rq5 is not related to any other record. In this case, the input-output management unit 22 does not update the relevance storage table 34 as illustrated in FIG. 11E.

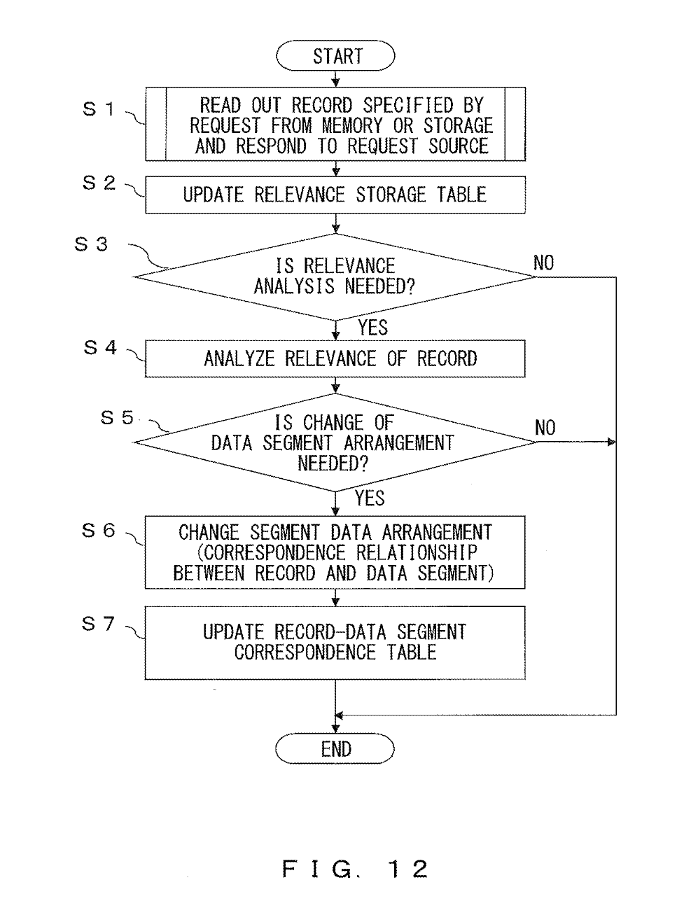

FIG. 12 is an example of a flowchart illustrating a flow of the entire update processing of the data segment management table performed according to a request arrival of the present embodiment. This flowchart is performed whenever the request is input to the server 11.

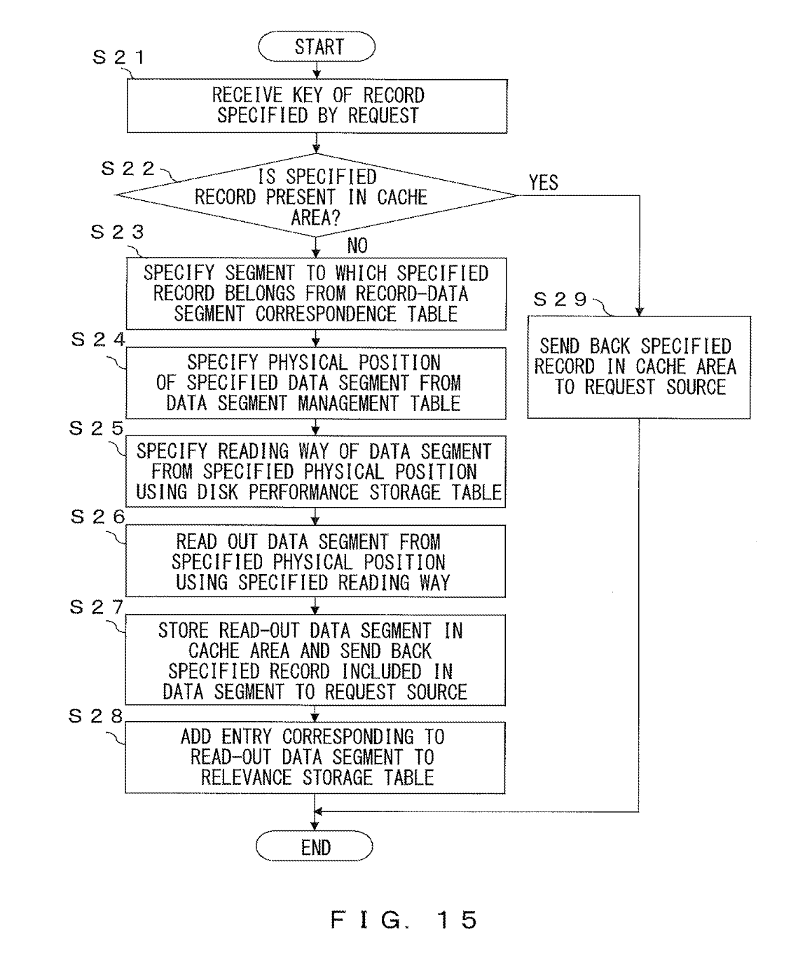

First, the input-output management unit 22 reads out the record specified by the request from the memory 31 or the disk 41, and transmits the record to the request source (S1). At this time, when the record specified by the request is not present in the memory 31, the input-output management unit 22 reads out from the disk 41 all the records of the data segment to which the record specified by the request belongs using the record-data segment correspondence table 33. From among all the records of the read-out data segment, the input-output management unit 22 further transmits the record specified by the request to the request source. A process of S1 will be described in detail in FIG. 15.

Next, the input-output management unit 22 refers to the record specified by the previous request included in the current request, and updates the relevance storage table 34 (S2). A process of S2 corresponds to the process illustrated in FIGS. 10 and 11.

When the relevance storage table 34 is updated, the analysis necessity determination unit 23 determines whether the relevance analysis according to the relevance analysis unit 24 is needed (S3). That is, based on the record-data segment correspondence table 33, the analysis necessity determination unit 23 determines whether the record (current record R1) specified by the current request and the record (previous record R2) specified by the previous request belong to different data segments. When the current record R1 and the previous record R2 belong to the same data segment, namely, when it is determined that the relevance analysis is not needed (“NO” at S3), the control device 21 finishes the process of this flowchart.

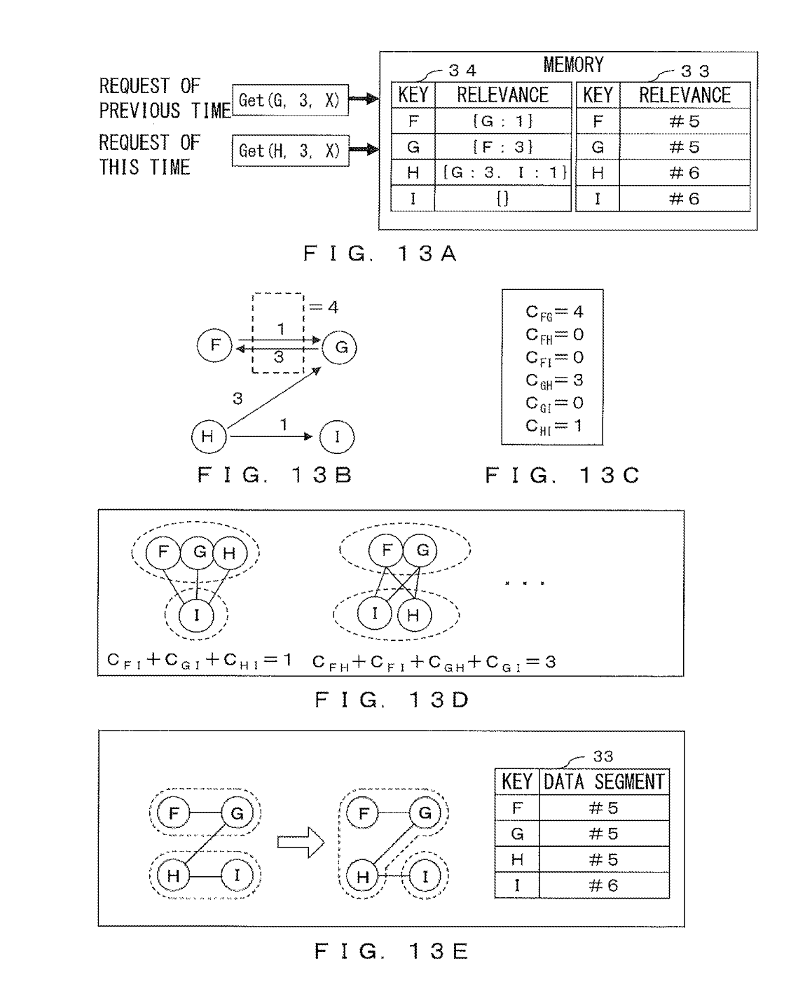

When the current record R1 and the record R2 of the previous time belong to the different data segments, namely, when it is determined that the relevance analysis is needed (“YES” at S3), the relevance analysis unit 24 analyzes the relevance of the record (S4). Further, the relevance analysis unit 24 analyzes the relevance between the data, for example, using a graph division method. Here, between all the records included in the data segment to which the current record R1 belongs and all the records included in the data segment to which the record R2 of the previous time belongs, the relevance analysis unit 24 demands a combination of two records, and calculates an intensity of the relevance between the two records. Here, the intensity of the relevance between the records is a value obtained by multiplying the number of times of the access illustrated in FIGS. 10 and 11 by the importance level. Further, the relevance analysis unit 24 obtains patterns of two data segments, for example, within a range of a rule of the data segment. In each pattern, the relevance analysis unit 24 calculates a total of the intensities of the relevances in a combination of respective records across the two data segments. According to the total, the relevance analysis unit 24 determines the pattern of the data segment. A process of S4 will be described in detail using FIGS. 13A-13E.

Next, based on the analysis results of the relevance analysis unit 24, the data segment arrangement unit 25 determines whether a change in the correspondence between the record and the data segment is needed, namely, whether a reorganization of the data segments is needed (S5). When the data segment to which any of the records belong is not changed, namely, when it is determined that the change in the correspondence between the record and the data segment is not needed (“NO” at S5), the control device 21 finishes the process of this flowchart.

When the data segment to which the record belongs is changed, namely, when it is determined that the change in the correspondence between the record and the data segment is needed (“YES” at S5), the data segment arrangement unit 25 performs the next processing. That is, based on the results of the reorganization of the data segment at S5, the data segment arrangement unit 25 changes the correspondence between the record and the data segment (S6).

Based on the changed correspondence relationship between the record and the data segment, the data segment arrangement unit 25 updates the record-data segment correspondence table 33 (S7). As a result of the reorganization of the data segments at S5, for example, when the data segment to which the record belongs is changed, a data segment name corresponding to the “key” of the record is updated in the record-data segment correspondence table 33.

FIGS. 13A-13E illustrate the analysis processing (S4) according to the relevance analysis unit 24. As illustrated in FIG. 13A, the request received from the client X at this time is assumed to be Get (H, 3, X), and the request received from the client X the previous time is assumed to be Get (G, 3, X).

As illustrated in the record-data segment correspondence table 33, the current record H and the previous record G belong to different data segments, and therefore the analysis processing according to the relevance analysis unit 24 is performed.

A relationship between the records of the record-data segment correspondence table 33 is illustrated in FIG. 13B. Between all the records H and I included in the data segment #6 to which the current record H belongs and all the records F and G included in the data segment #5 to which the previous record G belongs, the relevance analysis unit 24 obtains a combination of two records and calculates the intensity of the relevance between the two records. When the two records are related to each other, the relevance analysis unit 24 sets a sum of the intensities of the relevances to the intensity of the relevance between the records. As illustrated in the records F and G, for example, when the record G is related to the record F and the record F is related to the record G, a sum 4 of the relevance intensity=1 of the record G to the record F and the relevance intensity=3 of the record G to the record F is calculated.

Thereby, the intensities of the relevances between respective records C_{FG}=4, C_{FH}=0, C_{F1}=0, C_{GH}=3, C_{GI}=0, and C_{HI}=1 in a combination of two records between two data segments are obtained as illustrated in FIG. 13C. Here, the intensity C of the relevance between the records having no relevance is represented by 0.

The relevance analysis unit 24 is assumed to set all data segment patterns in which the number of all the records which belong to two data segments is divided, for example, within a range in which a maximum number of the records (e.g., 3) within the data segment is satisfied. In an example of FIG. 13B, the number of the records is assumed to be 4 (records F to I) and the maximum number of the records containable in one data segment is assumed to be 3. At this time, when the records are divided with a ratio of 3:1, there are four data segment patterns ((FGH) (I), (GHI) (F), (HIF) (G), and (FGI) (H)). Further, when the records are divided with a ratio of 2:2, there are six data segment patterns ((FG) (HI), (FH) (GI), (FI) (GH), (GH) (FI), (GI) (FH), and (HI) (FG)). As described above, ten data segment patterns are set in total.

Next, as illustrated in FIG. 13D, when the respective data segment patterns are adopted, the relevance analysis unit 24 extracts and totalizes all the intensities of the relevances of both the records that belong to different data segments.

Further, the relevance analysis unit 23 selects the data segment pattern in which a total of the intensities of the relevances of a combination of the records that belong to different data segments is minimized, and determines a new data segment (S17). In the case of FIG. 13B, equations hold as follows.

C_{FI}+C_{GI}+C_{HI}=1 (FGH) (I):

C_{FG}+C_{FH}+C_{FI}=4 (GHI) (F):

C_{FG}+C_{GH}+C_{GI}=7 (HIF) (G):

C_{FH}+C_{GH}+C_{HI}=3 (FGI) (H):

C_{FH}+C_{FI}+C_{GH}+C_{GI}=3 (FG) (HI):

C_{FG}+C_{FI}+C_{GH}+C_{HI}=8 (FH) (GI):

C_{FG}+C_{FH}+C_{GI}+C_{HI}=5

Thus, in all the data segment patterns, the total of the intensities of the relevances between the records of the data segment pattern of the data segments (FGH) and the data segment (I) is 1, and is minimized. Accordingly, the relevance analysis unit 24 determines that the above data segment pattern of (FGH) and (I) is a new data segment.

As illustrated in FIG. 13E, the data segment arrangement unit 25 changes the correspondence between the records and the data segments based on the analysis results according to the relevance analysis unit 24 (S6). Further, the data segment arrangement unit 25 updates the record-data segment correspondence table 33 based on the changed correspondence relationship between the records and the data segments.

In addition, in FIG. 13, when the intensity C is calculated, the intensity (value obtained by multiplying the number of times of the access by the importance level) of the relevance between the records is used; however, it is not limited to a method for using the relevance in which the number of times of the access and the importance level are weighted. For example, the relevance between one record and another record is uniformly set to 1, and the calculation maybe performed like the above. In this case, C_{FG}=2, C_{FH}=0, C_{FI}=0, C_{GH}=1, C_{GI}=0, and C_{HI}=1 are obtained.

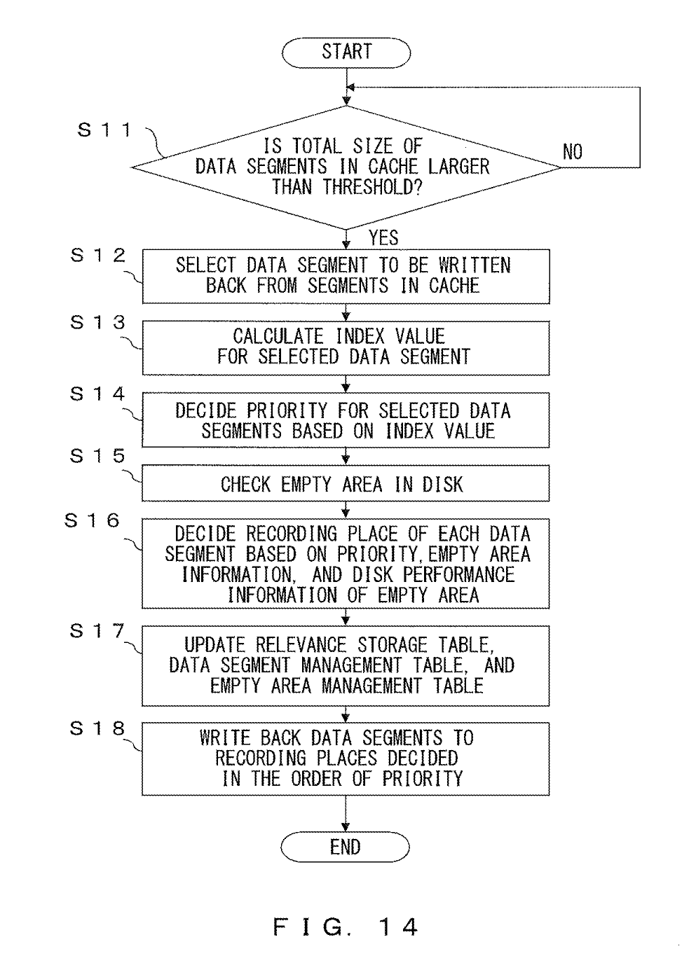

FIG. 14 is a write-back flowchart of the data segment to the disk of the present embodiment. In each case of the record processing (may be regularly), the input-output management unit 22 checks a size of the total of the data segments in the cache area 32, and determines whether the capacity of the cache area 32 is deficient (S11). Examples of the case in which the capacity of the cache area 32 is deficient include a case in which the capacity of the cache area 32 is deficient at the time in which the data segment read out from the disk 41 is stored in the cache area 32, a case in which data larger than a threshold are stored in the cache area 32, and the like. Here, a case of the latter will be described as an example. The input-output management unit 22 determines whether a size of the total of the data segments in the cache area 32 is larger than the prescribed threshold. As the threshold, for example, 90% of the capacity of the cache area 32 etc. is set to the prescribed memory area.

When it is determined that the total size is larger than the prescribed threshold (“YES” at S11), the input-output management unit 22 instructs the write-back execution unit 26 to write back the data segments in the cache area 32 to the disk 41.

From the data segments in the cache area 32, the write-back execution unit 26 selects a plurality of data segments so that the prescribed number of the data segments is selected or a size of the total is the prescribed size (S12).

A method for selecting a data segment includes a random selection method, an LRU algorithm, and an LFU algorithm. The random selection method is, for example, a method for selecting one or more data segments at random from a plurality of data segments in the cache area 32. The LRU algorithm is an algorithm for cuing the data segments in the order of the access and selecting a data segment from the data segments that have not been accessed for the longest time. The LFU algorithm is an algorithm for cuing the data segments in the order of the access frequency and selecting a data segment from the data segments in which the access frequency is lowest.

The total size or the number of the data segments to be selected depends on how wide a recording place is desired to be adjusted between the data segments. For example, the number of the data segments to be selected is considered to be set to five times the number of areas in the disk 41.

When an instruction is received from the write-back execution unit 26, the characteristic extraction unit 27 calculates the index value in each data segment as described later with respect to all the selected data segments, and stores the calculated index values in the data segment management table (S13). That is, using the record-data segment correspondence table 33 and the relevance storage table 34, the characteristic extraction unit 27 totalizes the intensities (=the number of times of the access×the importance level) of the relevances of all the records included in the data segments in units of the selected data segment.

In the case of the record-data segment correspondence table 33 of FIG. 5 and the relevance storage table 34 of FIG. 6, for example, the records that belong to the data segment #1 are A and C, the intensity of the relevance of the record A is 3, and the intensity of the relevance of the record C is 1. In this case, as the index value of the data segment #1, 3+1=4 is obtained.

The index value in each data segment may be updated whenever the data segment is changed. Further, the index values may be collectively calculated in the write-back processing.

The priority calculation unit 28 determines respective priorities of the selected data segments according to a size of the index value of the data segment calculated at S13 (S14). That is, the priority calculation unit 28 sets the data segment to have a higher priority as the index value of the data segment becomes larger.

The recording place determining unit 29 confirms the empty area in the disk 41 (S15). That is, the recording place determining unit 29 specifies a physical position of the empty area in the disk 41 from the empty area management table 36.

From the disk performance storage table 37, the recording place determining unit 29 obtains the readout performance of the physical position range corresponding to the specified empty area. The recording place determining unit 29 sequences the empty areas in the order of the higher readout performance in the physical position range.

The recording place determining unit 29 determines that the data segment to which the priority is given is allocated, in the order of higher priority, to the empty area in which the readout performance is higher (S16). When the plurality of data segments are allocated to the same physical position range, the recording place determining unit 29 allocates the data segment having higher priority, for example, to the area in which a physical position number is smaller.

Based on the determined allocation content, the recording place determining unit 29 updates the relevance storage table 34, the data segment management table 35, and the empty area management table 36 (S17). Specifically, the recording place determining unit 29 deletes an entry of the data segment selected at S12 from the relevance storage table 34. Further, the recording place determining unit 29 adds to the data segment management table 35 the entry corresponding to the area to which the data segment is allocated. Further, from the empty area management table 36, the recording place determining unit 29 deletes the entry corresponding to the area to which the data segment is allocated.

The write-back execution unit 26 writes back the data segment to the recording place determined in the order of the priority at S16 (S18).

FIG. 15 illustrates a detailed flowchart of the process (S1) until the record specified by the request of the present embodiment is read out from the memory 31 or the disk 41 and is transmitted to the request source. The flowchart of FIG. 15 illustrates details of the flow of S1 of FIG. 12.

The input-output management unit 22 receives the request from the client 51 and obtains the key of the record specified by the request (S21). Based on the obtained key, the input-output management unit 22 determines whether the record specified by the request is present in the cache area 32 (S22). When the specified record is present in the cache area 32 (YES at S22), the input-output management unit 22 sends back the record read out from the cache area 32 to the request source (S29).

When the specified record is not present in the cache area (NO at S22), the input-output management unit 22 specifies from the record-data segment correspondence table 33 the data segment to which the specified record belongs (S23).

From the data segment management table 35, the input-output management unit 22 specifies the physical position of the specified data segment (S24). Using the disk performance storage table 37, the input-output management unit 22 specifies the reading method of the data segment from the specified physical position (S25).

Using the specified reading method, the input-output management unit 22 reads out the specified data segment from the specified physical position of the disk 41 (S26). For example, when the reading method specified from the disk performance storage table 37 is “collective reading of ten data segments”, the input-output management unit 22 collectively reads out the ten data segments at the periphery or arranged continuously, including the specified data segments from the physical position of the specified data segment.

Only whether the collective reading is performed in each area is previously determined of the reading method. When the physical position of the data segment is actually specified, whether the collective reading is performed from the physical position may be determined.

Further, a unit of the collective reading may be determined according to a size (the number of the requests received per unit time by the input-output management unit 22) of the load. For example, the unit of the collective reading may be adjusted so that the unit of the collective reading is made to be large at the time of a large load and the unit of the collective reading is made to be small at the time of a small load.

The input-output management unit 22 stores the read-out data segment in the cache area 32 and sends back the specified record included in the data segment to the request source (S27). The input-output management unit 22 adds to the relevance storage table 34 the entry corresponding to the read-out data segment (S28).

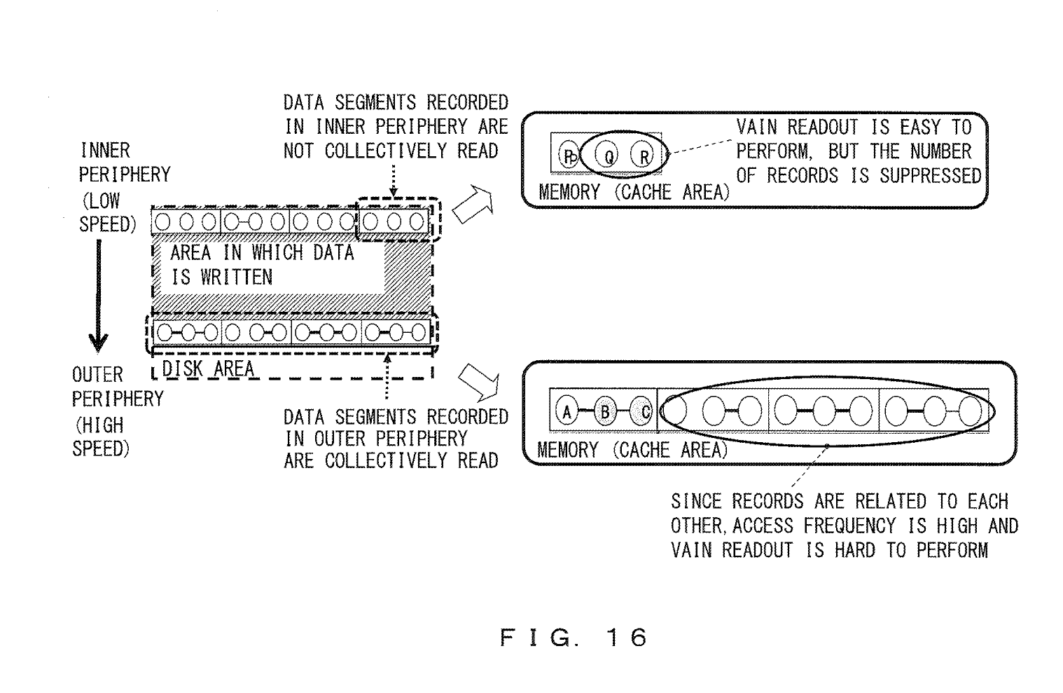

FIG. 16 illustrates an arrangement of the data segment and the reading unit of the data segment according to the reading efficiency of the present embodiment. On the outer peripheral side of the disk 41, the data segments in which a read-out speed of the disk is higher, the readout performance is higher, and the reading efficiency is higher are arranged. On the inner peripheral side of the disk 41, the data segments in which the read-out speed of the disk is lower, the readout performance is lower, and the reading efficiency is lower are arranged.

In the data segments arranged on the outer peripheral side, the plurality of data segments are assumed to be collectively read. In the data segments arranged on the inner peripheral side, the plurality of data segments are assumed to not be collectively read.

In FIG. 16, for example, in the data segments arranged on the outer peripheral side, four data segments are collectively read out by the readout processing of one time, and are held in the cache. At this time, when the record A is accessed, the records B, C and other records are also held in the cache all together. The records A, B, and C are related to each other, and therefore the records B and C are also easy to access while being held in the cache. Accordingly, the cache hit ratio becomes high. As described above, the records read out to the cache are related to each other, and therefore the access frequency also is high and it is difficult to perform useless readouts.

Further, in the data segments arranged on the inner peripheral side, one data segment is read out by the readout processing of one time, and is held in the cache. At this time, when a record P is accessed, records Q and R also are held in the cache all together. The records P, Q, and R are not related to each other, and therefore a ratio by which the records Q and R are also accessed while being held in the cache is low. That is, the records Q and R are read out uselessly. However, only the records Q and R are read out uselessly, and therefore the number of the records that are read out uselessly can be suppressed.

According to the present embodiment, according to the relevance between the records included in the data segment generated based on the access history of the data, an arrangement of the data segments in the disk can be determined and written back to the disk. As a result, the data segment in which the reading efficiency is high is recorded in the area in which the sequential read performance is high, and the data segment in which the reading efficiency is low is recorded in the area in which the sequential read performance is low. Therefore, an increase in the read cost can be suppressed.

Further, when the data segment is read out from the disk, the number of the data segments to be read out can be controlled according to the sequential read performance of the reading position in the memory area of the disk. That is, as the sequential read performance of the reading position becomes higher, the number of the data segments to be readout is further increased. On the other hand, as the sequential read performance of the reading position becomes lower, the number of the data segments to be read out is further reduced. As a result, an increase in the read cost can be suppressed.

According to one aspect of the present embodiment, the reading efficiency of the data from the memory device in which the readout performance differs according to positions in the memory area can be improved.

The present invention is not limited to the above-described embodiments, and various configurations or embodiments can be implemented without departing from the gist of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a data arrangement program that causes a computer to execute a process comprising:
selecting one or more data segments from a first storage device according to a free capacity of the first storage device that stores a plurality of data segments, each of the plurality of data segments being a data group grouped according to data relevance between data included in the data group;
calculating an evaluation value based on the data relevance between the data included in the selected data segments; and
determining arrangement positions of the selected data segments in storage areas of a second storage device based on the evaluation value and readout performance information of a plurality of storage areas in the second storage device in which readout performance differs by the plurality of storage areas.

2. The non-transitory computer-readable recording medium according to claim 6, wherein
the calculating calculates the evaluation value to be higher as the data relevance between the data included in the data segments becomes stronger, and
based on the evaluation value and the readout performance information, the determining determines that the arrangement positions becomes higher in the readout performance as the evaluation value of the data segments becomes higher.

3. The non-transitory computer-readable recording medium according to claim 6, the data arrangement process further comprising:
writing the selected data segments in the storage areas based on the determined arrangement positions.

4. The non-transitory computer-readable recording medium according to claim 6, the data arrangement process further comprising:
changing the number of data segments to be read out from the storage areas according to the arrangement positions of the data segments including data specified by a read request; and
reading out the data segments arranged continuously in the storage areas from the arrangement positions by the number of the data segments.

5. The non-transitory computer-readable recording medium according to claim 6, wherein
the data relevance is data relevance between data generated from an access history of the data.

6. A data arrangement apparatus comprising
a processor that performs a process including:
selecting one or more data segments from a first storage device according to a free capacity of the first storage device that stores a plurality of data segments, each of the plurality of data segments being a data group grouped according to data relevance between data included in the data group;
calculating an evaluation value based on the data relevance between the data included in the selected data segments; and
determining arrangement positions of the selected data segments in storage areas of a second storage device based on the evaluation value and readout performance information of a plurality of storage areas in the second storage device in which readout performance differs by the plurality of storage areas.

7. The data arrangement apparatus according to claim 6, wherein
the calculating calculates the evaluation value to be higher as the data relevance between the data included in the data segments becomes stronger, and
based on the evaluation value and the readout performance information, the determining determines that the arrangement positions becomes higher in the readout performance as the evaluation value of the data segments becomes higher.

8. The data arrangement apparatus according to claim 6, wherein
the process further includes writing the selected data segments in the storage areas based on the determined arrangement positions.

9. The data arrangement apparatus according to claim 6, wherein
the process further includes
changing the number of data segments to be readout from the storage areas according to the arrangement positions of the data segments including data specified by a read request; and
reading out the data segments arranged continuously in the storage areas from the arrangement positions by the number of the data segments.

10. The data arrangement apparatus according to claim 6, wherein
the data relevance is data relevance between data generated from an access history of the data.

11. A data arrangement method executed by a computer, the data arrangement method comprising:
selecting one or more data segments from a first storage device according to a free capacity of the first storage device that stores a plurality of data segments, each of the plurality of data segments being a data group grouped according to data relevance between data included in the data group;
calculating an evaluation value based on the data relevance between the data included in the selected data segments; and
determining arrangement positions of the selected data segments in storage areas of a second storage device based on the evaluation value and readout performance information of a plurality of storage areas in the second storage device in which readout performance differs by the plurality of storage areas.

12. The data arrangement method according to claim 11, wherein
the calculating process calculates the evaluation value to be higher as the data relevance between the data included in the data segments becomes stronger, and
based on the evaluation value and the readout performance information, the determination process determines that the arrangement positions becomes higher in the readout performance as the evaluation value of the data segments becomes higher.

13. The data arrangement method according to claim 11, the data arrangement further comprising
writing the selected data segments in the storage areas based on the determined arrangement positions.

14. The data arrangement method according to claim 11, the data arrangement further comprising:
changing the number of the data segments to be read out from the storage areas according to the arrangement positions of the data segments including data specified by a read request; and
reading out the data segments arranged continuously in the storage areas from the arrangement positions by the number of the data segments.

15. The data arrangement method according to claim 11, wherein
the data relevance is data relevance between data generated from an access history of the data.
